(19) United States
(12) Patent Application Publication
(10) Pub. No.: US 2002/0143850 A1
(43) Pub. Date: Oct. 3, 2002

(54) Method and apparatus for progressively processing data

(76) Inventors: Germano Caronni, Palo Alto, CA (US); Radia Perlman, Carlisle, MA (US)

Correspondence Address: THE HECKER LAW GROUP, 1925 CENTURY PARK EAST, SUITE 2300, LOS ANGELES, CA, 90067, US

(21) Appl. No.: 09/819,223

(22) Filed: Mar. 27, 2001

(51) Int. Cl. G06F 15/16; H04L 9/00

(52) U.S. Cl. 709/201

(57) ABSTRACT

A method and apparatus for progressively processing data is described. One or more embodiments of the invention provide for using multiple processing nodes to perform data processing. Each node may perform part or all the steps involved in data processing. Processing nodes use progress indicators to communicate the status of the processing progress. An embodiment of the invention use progressive processing and progress indicators to perform incremental processing where data processing is performed in sequence by multiple processing nodes. Another embodiment uses progressive processing and progress indicators to delegate processing by one processing node to another processing node dedicated to providing a specific service. This method provides for efficient usage and management of data processing resources, and allows single intermediate processing node to share the processing load with other processing nodes.

### FIELD OF THE INVENTION

This invention relates to the field of electronic data processing in a network of data processing nodes.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever. Sun, Sun Microsystems, the Sun logo, Java, and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

### BACKGROUND OF THE INVENTION

In modem computing environments, multiple computers or workstations may be linked together in a network providing for communication and data sharing within and across networks. A network may also include resources, such as printers, modems, file servers, etc., and services such as electronic mail and data storage and transmission. A network may include multiple computers and may also be composed of multiple sub-networks. For example, the Internet is a worldwide network of interconnected computers. Information travels between individual networks in discrete “packets” with an addressing scheme to identify the packet's destination and where it originated. Packets from many sources are collected, transmitted, and routed to the appropriate addresses. Additionally, computers may host a variety of software applications and services running altogether in a multitasking environment. These software applications (or processes) may exchange data with each other through inter-process communication pipes.

Each computing device within a network and software application may be viewed as a data processing node providing a plurality of computing services such as cryptographic processing, file scanning, calculation of hash functions, checking data authenticity, performing intrusion detection checks, compression and quality reduction etc. For example, to protect information in the receiving internal computer network from undesirable external access, a firewall or router may be utilized. A firewall is a mechanism that filters data and blocks unauthorized access between external computers and the computers within a network. Firewall or routing software typically retains the ability to communicate with external sources, yet is trusted to communicate with the internal network.

In current architectures processing nodes queue unprocessed incoming data in data queues (e.g. memory caching and file caching), and process the data in one of several ways of managing process queues (e.g. first in first out, last in first out etc.). However, data may accumulate at the processing node when the processing node must handle a high volume of incoming data. The need for extensive computer processing and the accumulation of unprocessed data (e.g. email messages) may lead to bottlenecks, and ultimately loss of data if a processing node cannot properly handle the stream of data, even when plenty of computation resources are available at other processing nodes.

In an attempt to ease this problem, current systems use network load balancing techniques and parallel processing using additional equipment. These systems use routing techniques (e.g. round-robin and random load balancing) to distribute packets of incoming data across a number of processing nodes. However, load-balancing techniques are of limited use. For example, current load balancing techniques can only work on packeted data (e.g. TCP/IP protocols). Load-balancing techniques may not retrieve data packets from a processing node after the latter has already partially processed the data. Finally, load-balancing techniques do not provide means for keeping the status of the processing progress on each data packet.

As will be discussed in due course, the methods and procedures of this invention offer a way to overcome these difficulties.

### SUMMARY OF THE INVENTION

A method and apparatus for progressive processing of data is described. In an embodiment of the invention, multiple processing nodes may be involved in processing the data. Each node may perform part or all the processing on the data. Each node may also perform the same processing type as other processing nodes on the data or may perform part or all of the processing involved in a specific task. For example, in an embodiment of the invention a computer at the boundary of a secure network (e.g., a router or a firewall) may partially process data packets and dispatch them for further processing to other machines that are inside the secure network.

In an embodiment of the invention the data is tagged with one or more data entities referred to herein as progress indicators. A progress indicator contains information about whether the data packet has been partially processed, whether the receiving processing node should partially process the data, delay processing, resume processing, the remaining portion of processing and any information enabling a given processing node to check the processing progress status to perform further processing. Processing nodes may be configured to update the progress indicators to indicate the type of processing, the amount of processing that has been performed and the portion of data that has been processed. For example, in an embodiment of the present invention, a cluster of processing nodes may carry out scanning for viruses. Given a library of virus signatures, each node may scan the data for a certain number of viruses then may transfer the data to a different processing node (e.g. depending on the availability of processing resources). In this example the processing node will include, in the progress indicator, information about the amount of data that has been scanned, and an indication about the viruses for which scanning has been performed. The next processing node carries out further scanning starting where the previous processing node had stopped.

An embodiment of the invention provides incremental data processing where one or more processing nodes may carry out a subset of data processing steps, and other nodes may carry out another subset of subsequent data processing steps. For example, in an embodiment of the present invention multiple nodes may carry out cryptographic processing, in such a way that one intermediate node may unlock data packets so that other nodes may further process the packets. Furthermore, a node may unlock packets using a particular decryption technique, and subsequently dispatch data packets to other processing nodes that perform additional decryption conceivably using a different type of decryption technique. In this example, a first node may update the progress indicator with a variety of information such as the encryption key and/or the storage location thereof, the test result of the cryptographic processing, as well as any information that may be considered in further carrying out further steps of data processing.

An embodiment of the invention provides for delegation of partial processing to processing nodes with available resources. In an embodiment of the invention a first processing node may suspend a processing job when there is a need for a specific kind of processing that can be carried out by a different processing node, and transfer the data to a second processing node that may carry out data processing or forward the data to another processing node. The second node may return data to the first processing node after having performed a specific type or processing. For example, in an embodiment of the present invention a first node specialized in encrypting outgoing data may delegate the scanning for viruses to a second processing node enabled to scan for viruses. In this example the first node includes all the information about the status of the processing, the required type of processing, the processing step to be carried out after the second processing node has completed its task and all other information enabling the system to complete the processing.

In an embodiment of the invention, data processing may obey sets of rules where only certain processing nodes within a network of processing nodes may be involved in the data processing. For example, in an embodiment of the present invention a network of processing nodes may have some of the intermediate systems configured such that certain processing nodes are disallowed to further delegate processing. In this example, these intermediate systems can provide a hard boundary beyond which all data must have been processed.

### BRIEF DESCRIPTION OF THE DRAWINGS

FIGS. 1a and 1b is a block diagram describing the layout of a system composed of multiple processing nodes.

FIG. 2 shows a block diagram representing the interaction between progress indicator 220 and other sources of data and data processing computer programs.

FIGS. 3a and 3b show flowcharts representing the steps followed for partially processing and routing data in an embodiment of the present invention.

FIG. 4 is a block diagram of one embodiment of a computer system capable of providing a suitable execution environment for one or more embodiments of the invention.

FIG. 5 shows a flowchart representing the steps of executing incremental data processing in an embodiment of the present invention that implements progressive processing.

FIG. 6 shows a flowchart illustrating the delegation of processing during the execution of a three-phase data processing task.

### DETAILED DESCRIPTION

A method and apparatus for progressive processing of data is described. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Multiple Processing Nodes:

In an embodiment of the present invention, multiple processing nodes may be involved in processing the data. Each node may perform part or all the processing on the data. Each node within an interconnected set of nodes may also perform the same data processing type as other processing nodes, and may perform part or all of the data processing involved in a specific task. For example, in an embodiment of the invention a computer at the boundary of a trusted network (e.g., a router or a firewall) may partially process data packets and dispatch them to other processing nodes within the trusted network for further processing.

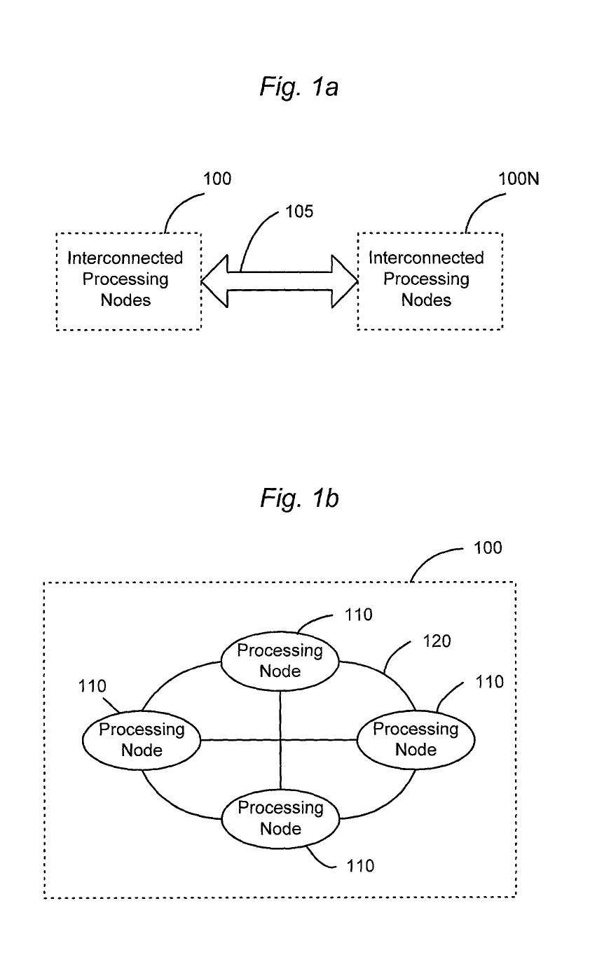

FIGS. 1a and 1b is a block diagram describing the layout of a system composed of multiple processing nodes in an embodiment of the present invention. A processing node is any hardware or software entity capable of processing information. Examples of processing nodes comprise a computer such as the one described hereinafter, a software application such as a virtual machine (e.g. JAVA™ virtual machine) running on a computer, a circuit board capable of processing data and any device capable of processing data. Processing nodes may be interconnected to form clusters of processing nodes.

FIG. 1a shows a block diagram representing the basic architecture of networked clusters of processing nodes 100 and 100N. Each cluster 100 may be connected to one or more clusters 100N using any type of networking means 105 capable of transmitting data between clusters. Examples of clusters for processing data comprise firewalls, proxy servers, load balancing machine and any other type of computer for processing data. Other examples of clusters of processing nodes comprise software programs that may run one or more machines.

The connection 105 linking a cluster 100 with other systems and clusters 100N may be any type of networking connection. For example, cluster 100 may be connected to other clusters through the Internet, wire connection and radio wave-based means.

FIG. 1b shows a block diagram of a cluster of processing nodes. In the example presented in FIG. 1b four nodes are inter-connected. In this example, the processing nodes may be hardware devices (e.g. computers as described above) interconnected through network connections 120. In other examples, processing nodes may be software applications. Examples of links between processing nodes 120 comprise software applications standard input, standard output, pipes, TCP/IP sockets and any means and protocols capable of transmitting data between software applications. For example, in an embodiment of the present invention, a computer comprising multiple processors may run multiple copies of the same application, where each copy, being a processing node may run on a separate processor. The processing nodes, in this example, may be connected through anyone of the protocols available to establish data exchange connections between applications.

In an embodiment of the present invention, processing data may involve multiple nodes, where each node may carry out a specific type of processing or part thereof. The present invention describes an embodiment enabling multiple nodes to carry out progressive processing by sharing the status of the processing progress.

An embodiment of the present invention uses a data entity to which it is referred as progress indicator. A Progress indicator contains information and references to information enabling the system to track processing progress. In an embodiment of the present invention the progress indicator is a data structure that is attached to data packets. In other embodiments of the present invention progress indicator may be a data structure independently transferred between processing nodes. Progress indicator may also be a set of data stored on a remote server accessible to processing nodes that are involved in data processing.

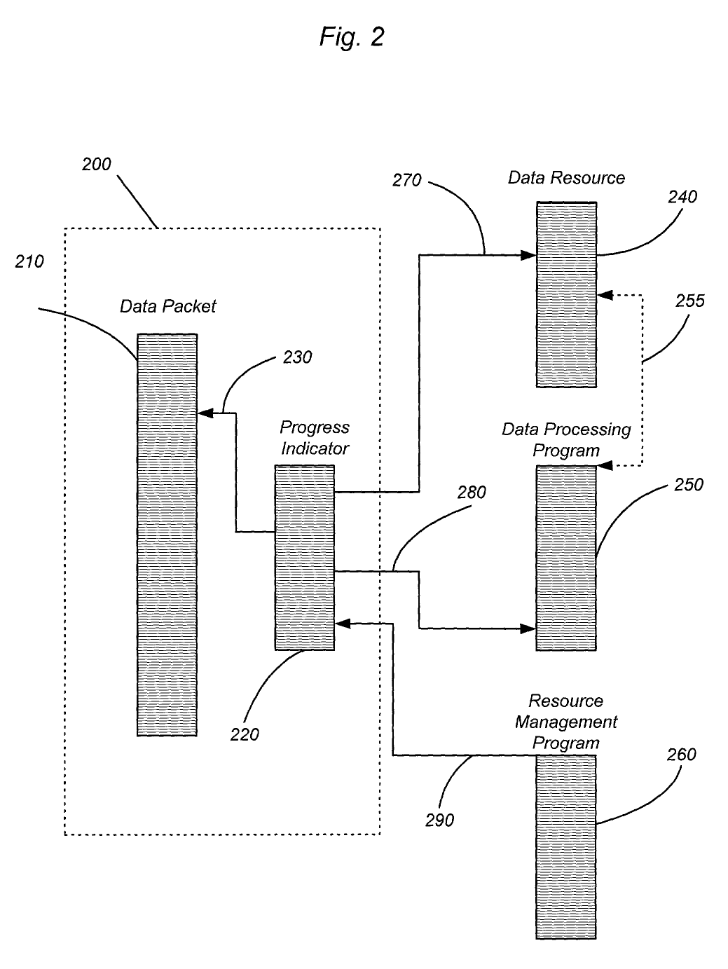

FIG. 2 shows a block diagram representing the interaction between progress indicator 220 and other sources of data and data processing computer programs. Progress indicator 220 contains one or more links 230 to the data being processed. FIG. 2 illustrates an example of a data packet 210. In other instances data may be represented with data streams or files or any data input and output means.

Progress indicator 220 is linked to a variety of data source and program sources. In an embodiment of the present invention represented in FIG. 2, the progress indicator is linked to a data resource 240. Examples of data resources comprise databases (e.g. relational database), flat files, a hash table and any data storage media. The link between the progress indicator and the data resource may be a reference such as a pointer to the row in a database or in a flat file, or may hold the value of the referenced data such as an access key in a hash table. For example, an embodiment of the present invention is a system for scanning incoming data for viruses. The system comprises one or more processing nodes that have access to a library of virus signatures (data resource). Such a library may be stored in a relational database, flat file, hash table or obtained from a server. Each node is enabled to access the virus signature library and scan the data for the presence of any of the virus signatures. In this example, the progress indicator contains a reference or a pointer to the virus signature being scanned. The location of the data may be a key in a hash table, the value of the virus signature itself or any indicator allowing the system to determine the virus signature.

In an embodiment of the present invention the progress indicator 220 contains one or more references 280 to the data processing program 250 executed on the data. The reference allows the system to determine progress status of the processing. In an embodiment of the present invention the progress indicator 220 contains a data entry or a reference 209 to a data structure holding information about the processing node resources. Resources comprise all system resources allowing the processing node to carry out data processing. Examples of system resources comprise CPU time, memory size, storage space and any resource allowing a computing device to perform data processing. In an embodiment of the present invention represented in FIG. 2, a management program 260 handles processing node's resource information. For example, during execution of a data processing program resources information may be updated in real time to indicate system availability. The data processing program may use the resource information to make execution decisions such as suspending processing for a predetermined amount of time or routing the data to another processing node. In the virus-scanning example described above, a data processing node may run low on memory due to high volume of incoming data. In this example, the processing node may be configured to suspend virus scanning and reroute the processing to a different processing node with available resources.

In an embodiment of the invention, the system comprises one or more sets of processing criteria or processing rules. Processing criteria indicate whether any given processing node is allowed to process the incoming data, associate a progress indicator with the data, forward the data, forward the data to specific processing nodes, process the data after receiving it from specific processing nodes and any criterion that may enable the system to properly perform data processing. Other processing criteria comprise security policies, access control to processing nodes, distribution policy, rerouting permissions etc. For example, in an embodiment of the invention, a cluster of networked computers, forming a sub-network, may run as a firewall where each computer may share progressive processing of incoming data only with other computers within the same sub-network. In this example, processing criteria can be provided at every processing node, or served by a dedicated server.

Progressive Processing

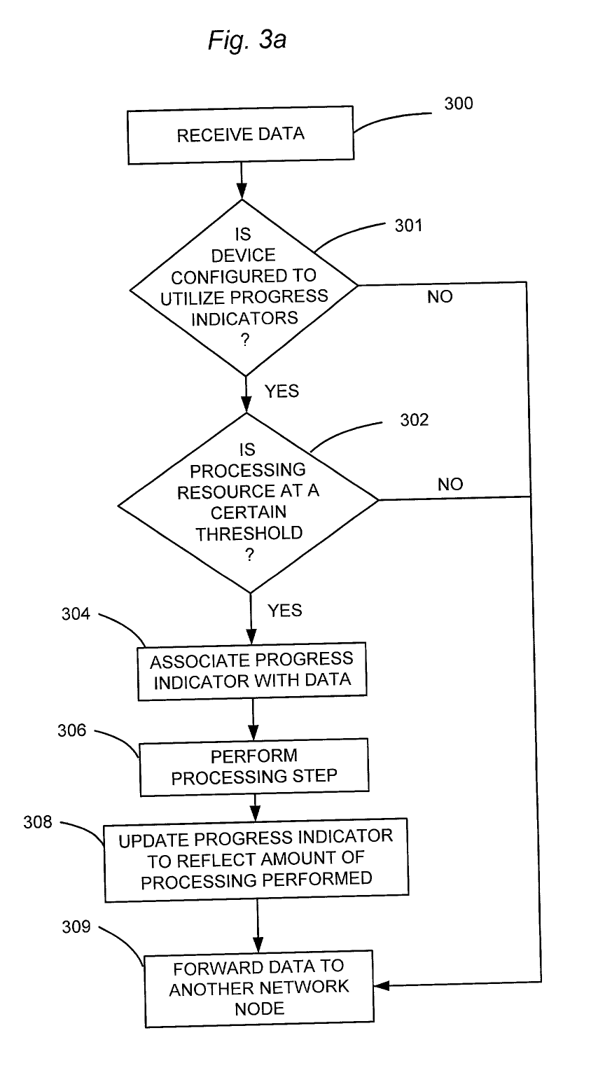

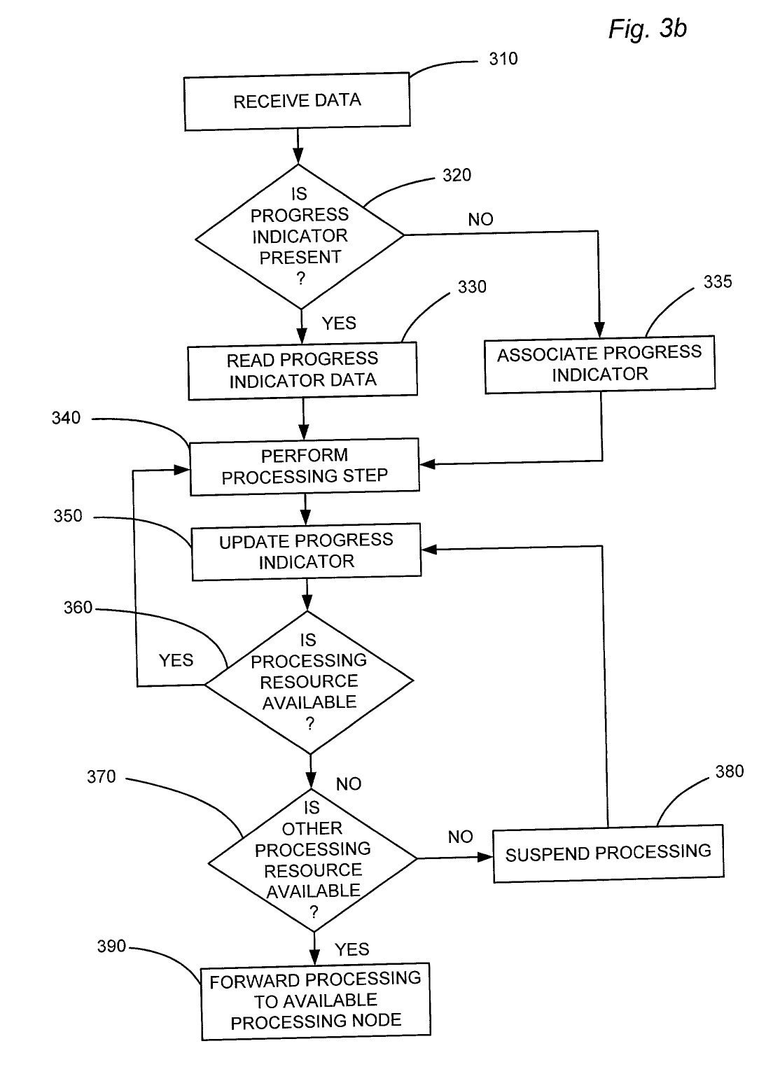

FIGS. 3a and 3b show flowcharts representing the steps followed for partially processing and routing data in accordance with an embodiment of the invention.

FIG. 3a show a flowchart representing the steps of receiving and routing data packets in accordance with an embodiment of the invention. At step 300 the device (e.g., a router or some other processing node) receives data from any data source configured to transmit data. If the device receiving the data is not configured to utilize progress indicators, the data is forwarded to another node (e.g., a router or processing node) by executing step 309. If the device is configured to utilize progress indicators (e.g., the device is capable of evaluating, processing, associating, or otherwise perform operations relating to progress indicators) with the data, steps 302-309 may execute (see e.g., step 301). At step 302 an embodiment of the invention determines if the resources (e.g., CPU time) of device supporting the use of progress indicators are available. The device is considered to have resources available when the amount of free resources is greater than or equal to an appropriate threshold (e.g., the system has X% of available CPU time). If the resource availability level is such that it does not allow for processing (e.g. during heavy network traffic) the processing node forwards the data packet to the another network node by executing step 309. If the processing resources are available the processing node may associate a progress indicator with the data (see e.g., step 304). The processing node may then perform data processing on the data in step 306 while processing resources are flagged as available. The invention contemplates various types of data processing and may be adapted to perform any type of processing that relates to the data received at step 300. Some examples of the type of processing the device embodying the invention may perform includes but is not limited to virus scanning, cryptography, and any other kind of processing that involves the computational resources of the device.

Once the processing is complete, the device is tasked with other higher priority jobs, or the device elects to stop processing prior to completely processing the packet data, the device updates the progress indicator (see e.g., step 308) to reflect the amount of processing performed. After the progress indicator is updated the device forwards the data comprising the progress indicator to another network node (see e.g., step 309) for processing. That node may or may not perform further processing before forwarding the data again. The reader should note that the step of associating a progress indicator may also be carried out after out after the step of performing data processing.

FIG. 3b shows a flowchart representing the steps followed for partially processing data in an embodiment of the invention. A processing node receives data in step 310 through one or more of the above mentioned data communication means and protocols. The processing nodes checks whether a progress indicator has been associated with the data in step 320. Checking for progress indicator may be carried out on the received data if the progress indicator data has been attached to the transmitted data, and may be fetched from another server using any type of reference to data to be processed. For example, if the system is configured such that progress indicator information is stored on a separate server accessible by the processing node. The processing node may access the server when it receives the data to retrieve progress indicator information using a reference to the data (e.g. a file name, a TCP/IP port number etc.).

If the test in step 320 fails, the processing node may implement a progress indicator associated with the data. The processing node may attach the progress indicator with the data or store it in a location accessible to all nodes involved in the processing of the data. The processing node may also reroute the data to a second server that is enabled to associate data with one or more progress indicators.

When the test in step 320 determines that a progress indicator is associated with the data, the processing node loads the processing progress information and proceeds to perform more processing on the data.

As mentioned above, the system updates the progress indicator throughout the processing time. In step 350 the information contained in the progress indicator, and the data referred to with references contained in the progress indicator may all be updated to reflect the status of the processing. The resource management program 260 tracks the resources usage and updates the system about the resource availability. The processing node may use any of the information provided by the resource management program to select further processing steps. In an embodiment of the present invention, the processing node may test in step 360 whether one or more resources have been exhausted (e.g. CPU time, number of suspended processes, available memory size). If resources are not available, the processing node may access other processing nodes to check for resource availability on the remote processing nodes in step 370. If the resources are not available on the other processing nodes, the processing node suspends processing in step 380. If processing resources are available on remote processing nodes, the data is transferred to another processing node with available resources in step 390. In another embodiment of the present invention, the system may be built such that the resources management program causes an interruption by hardware of software interrupt means well know in the art.

In an embodiment of the present invention, data processing nodes may suspend processing based on any predetermined set of rules. The processing node may also resume data processing based on one or more sets of rules. For example, the execution of a given process may be suspended for an unspecified amount of time (e.g. while waiting for a resource to become available), however if the suspension exceeds a certain amount of time the processing node may be configured to raise the priority to resume execution of the process. Raising the priority may involve, for example suspending processes that are using the resource, executing specific processes that free up the resource or rerouting the suspended process to another processing node.

Thus a method and system for performing progressive data processing is described. The system architecture is based on a multiplicity of data processing nodes connected to work in coordination. The method and system also contain data architectures (e.g. progress indicator) allowing processing nodes to intercommunicate the progress status of data processing. The following paragraphs describe instances where the present invention is used to accomplish progressive data processing.

Incremental Processing:

In an embodiment of the present invention, progressive processing is implemented to perform incremental data processing. In this embodiment a series of linked clusters, each comprised of one or more processing nodes, perform data processing where each cluster may be configured to perform only a limited number of steps of data processing.

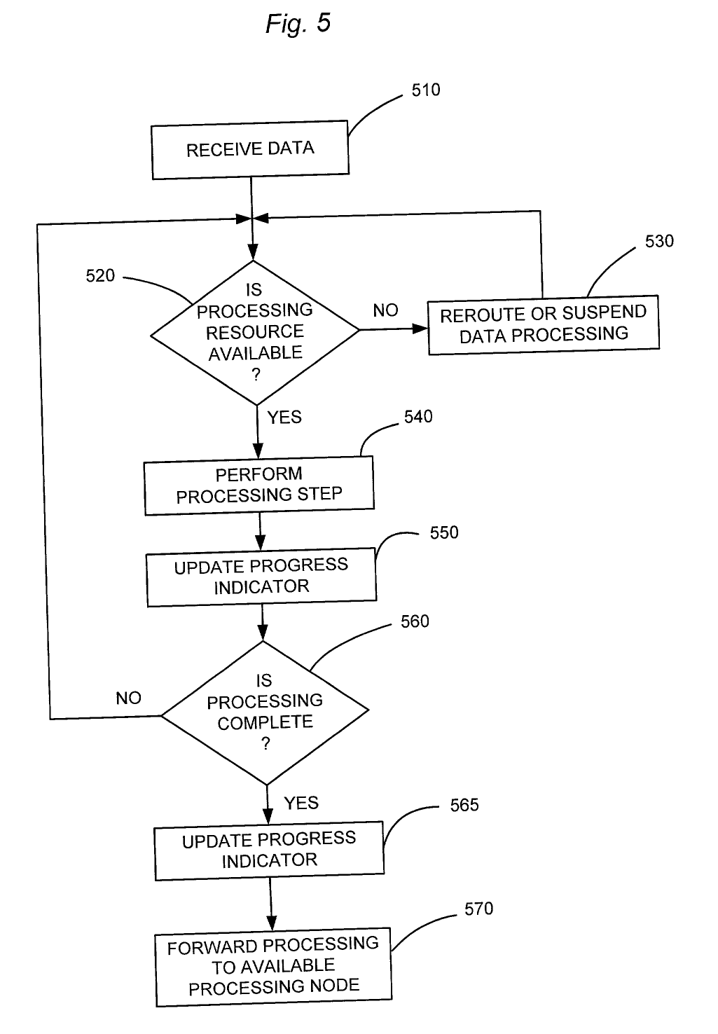

FIG. 5 shows a flowchart representing the steps of executing incremental data processing in an embodiment of the present invention that implements progressive processing. In this example a processing node receives data in step 510. The processing node tests whether the resources to process the data are available. If the processing node is unable to perform data processing it may suspend processing for a certain amount of time (as described in FIG. 3b step 350, 360, 370 and 380) or reroute the data to a processing node with available resources. If the resources are available, the processing node executes the next processing step in step 540 then updates the progress indicator in step 550. In this embodiment processing continues by looping back to step 520 if the completeness test in step 560 fails. When the processing is complete the progress indicator is updated with progress status information in step 570. The data is then transferred to the next processing cluster of processing nodes to perform subsequent data processing.

In an embodiment of the present invention, incremental processing is implemented in a system that performs cryptographic data processing at the border of a secure network. In this example, a cluster of one or more firewalls (processing nodes) may carry out a subset of data processing steps such as unlocking data packets received from a server located outside the network, so that other processing nodes may further process the packets. In another example, a first node may unlock packets using a particular decryption technique. The packets may then be dispatched to one or more subsequent processing nodes that perform additional decryption on the packets possibly using a different type of decryption. In this example, a first node may update the progress indicator with a variety of information such as the encryption key and/or the storage location thereof, the cryptographic processing success result, as well as any information that may be considered to perform further steps of cryptographic processing.

Delegation of Processing:

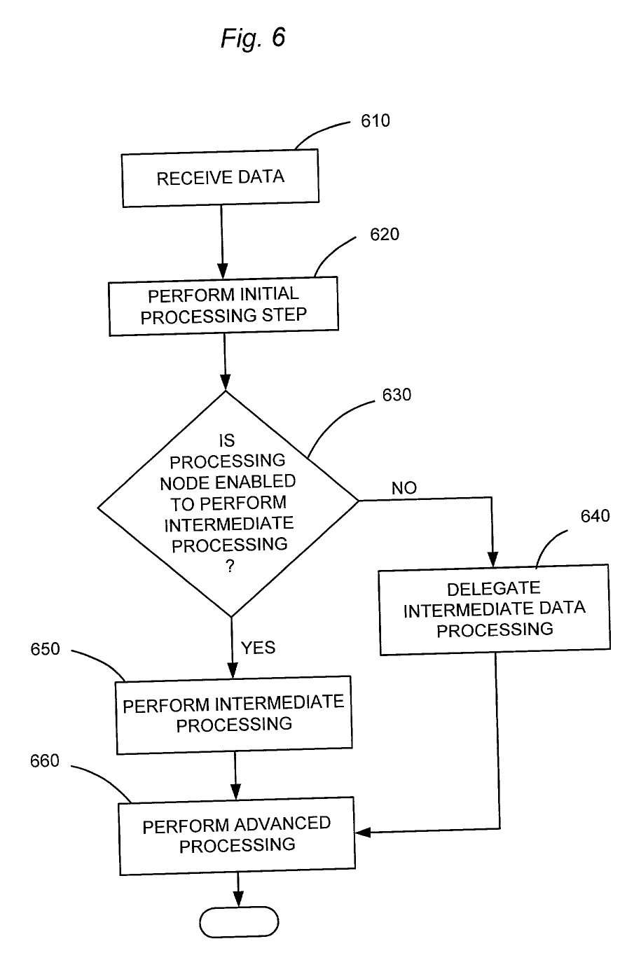

In an embodiment of the present invention, a processing node may delegate specific data processing to another processing node. FIG. 6 shows a flowchart illustrating the steps for processing data in three consecutive phases: initial, intermediate and advanced phases, in an embodiment of the invention. The processing node receives data for processing in step 610. In step 610 the processing node carries out the tests described in steps 320, 330 and 335. In this instance it is assumed that the present node is enabled to perform the initial and advanced processing phases and possibly the intermediate processing phase.

In step 620 the processing node performs the initial processing phase. This step may include resource availability test such as the one described in step 360. The processing node then tests whether it is enabled to perform the intermediate phase of data processing in step 630. If the test fails, the processing node may choose to delegate processing to a server configured to perform the intermediate phase of processing in step 640. The step of delegating data processing involves updating the progress indicator with information allowing the server performing the intermediate phase of data processing to carry out the processing and properly forward data for further processing to the original processing node or to other processing nodes. If the processing node is enabled to perform the intermediate processing phase, it proceeds to performing the intermediate processing phase in step 650 and the advanced processing phase in step 660.

In an embodiment of the present invention, delegation of processing is used to share server resources within a network of computers inside a secure network. For example, within a network one or more servers may be dedicated to perform data cryptographic processing, other servers may be configured to perform computer virus scanning on incoming and out going data in to and out of the secure network. Servers handling email traffic may, for example, delegate cryptographic processing and virus-scanning jobs to the servers dedicated servers to perform that specific type of job. In this example, the email server may start processing email content, and may require encrypting the data. In this example, the email server would load the processing progress status information into the progress indicator and forward the data to a server enabled to perform cryptographic processing. The encryption server returns the encrypted data with a progress indicator holding the progress information (e.g. encryption or decryption success) allowing the email server to continue processing the data.

Computer Execution Environment (Hardware)

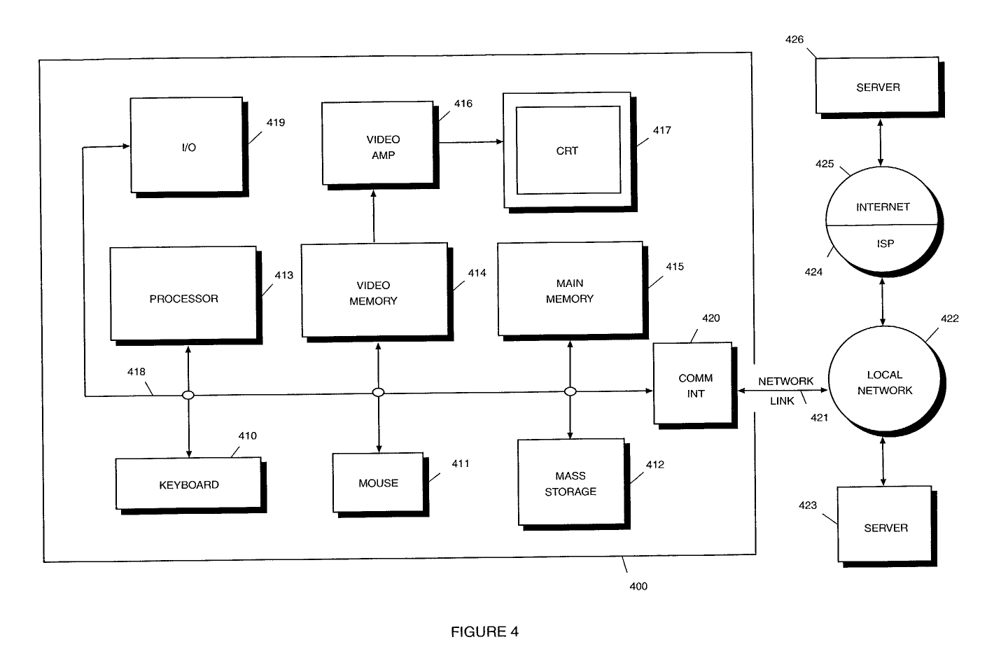

An embodiment of the invention can be implemented as computer software in the form of computer readable code executed on a general purpose computer such as computer 400 illustrated in FIG. 4, or in the form of byte code class files executable within a Java™ runtime environment running on such a computer, or in the form of byte codes running on a processor (or devices enabled to process byte codes) existing in a distributed environment (e.g., one or more processors on a network). A keyboard 410 and mouse 411 are coupled to a system bus 418. The keyboard and mouse are for introducing user input to the computer system and communicating that user input to processor 413. Other suitable input devices may be used in addition to, or in place of, the mouse 411 and keyboard 410. I/O (input/output) unit 419 coupled to system bus 418 represents such I/O elements as a printer, A/V (audio/video) I/O, etc.

Computer 400 includes a video memory 414, main memory 415 and mass storage 412, all coupled to system bus 418 along with keyboard 410, mouse 411 and processor 413. The mass storage 412 may include both fixed and removable media, such as magnetic, optical or magnetic optical storage systems or any other available mass storage technology. Bus 418 may contain, for example, thirty-two address lines for addressing video memory 414 or main memory 415. The system bus 418 also includes, for example, a 64-bit data bus for transferring data between and among the components, such as processor 413, main memory 415, video memory 414 and mass storage 412. Alternatively, multiplex data/address lines may be used instead of separate data and address lines.

In one embodiment of the invention, the processor 413 is a SPARC™ microprocessor from Sun Microsystems, Inc., or a microprocessor manufactured by Motorola, such as the 680X0 processor or a microprocessor manufactured by Intel, such as the 80X86, or Pentium processor. However, any other suitable microprocessor or microcomputer may be utilized. Main memory 415 is comprised of dynamic random access memory (DRAM). Video memory 414 is a dual-ported video random access memory. One port of the video memory 414 is coupled to video amplifier 416. The video amplifier 416 is used to drive the cathode ray tube (CRT) raster monitor 417. Video amplifier 416 is well known in the art and may be implemented by any suitable apparatus. This circuitry converts pixel data stored in video memory 414 to a raster signal suitable for use by monitor 417. Monitor 417 is a type of monitor suitable for displaying graphic images.

Computer 400 may also include a communication interface 420 coupled to bus 418. Communication interface 420 provides a two-way data communication coupling via a network link 421 to a local network 422. For example, if communication interface 420 is an integrated services digital network (ISDN) card or a modem, communication interface 420 provides a data communication connection to the corresponding type of telephone line, which comprises part of network link 421. If communication interface 420 is a local area network (LAN) card, communication interface 420 provides a data communication connection via network link 421 to a compatible LAN. Wireless links are also possible. In any such implementation, communication interface 420 sends and receives electrical, electromagnetic or optical signals that carry digital data streams representing various types of information.

Network link 421 typically provides data communication through one or more networks to other data devices. For example, network link 421 may provide a connection through local network 422 to local server computer 423 or to data equipment operated by an Internet Service Provider (ISP) 424. ISP 424 in turn provides data communication services through the worldwide packet data communication network now commonly referred to as the “Internet” 425. Local network 422 and Internet 425 both use electrical, electromagnetic or optical signals that carry digital data streams. The signals through the various networks and the signals on network link 421 and through communication interface 420, which carry the digital data to and from computer 400, are exemplary forms of carrier waves transporting the information.

Computer 400 can send messages and receive data, including program code, through the network(s), network link 421, and communication interface 420. In the Internet example, remote server computer 426 might transmit a requested code for an application program through Internet 425, ISP 424, local network 422 and communication interface 420.

Processor 413 may execute the received code as it is received, and/or stored in mass storage 412, or other non-volatile storage for later execution. In this manner, computer 400 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems programs, apparatus, and/or methods described above are for purposes of example only. An embodiment of the invention may be implemented in any type of computer system or programming or processing environment. Thus, a method and apparatus for providing processing services for data packets is described in conjunction with one or more specific embodiments. The invention is defined by the claims and their full scope of equivalents.

What is claimed is:

1. A method for progressively processing data comprising:
receiving data at a first node of a plurality of processing nodes;
associating an indicator comprising a state of progress with data;
executing processing of said data wherein an amount of said processing depends upon said state of progress;
transferring said processing to a second processing node.

2. The method of claim 1 wherein said associating occurs at one of said plurality of processing nodes.

3. The method of claim 1 wherein said state of progress indicates said amount of processing already performed.

4. The method of claim 1 wherein said indicator further comprises a result of said processing.

5. The method of claim 1 wherein said indicator comprises a reference to an amount of data processed.

6. The method of claim 5 wherein said reference comprises a pointer.

7. The method of claim 5 wherein said reference comprises a value.

8. The method of claim 1 wherein said indicator further comprises a pointer to a size of said data.

9. The method of claim 1 wherein said indicator comprises a reference to an external data source.

10. The method of claim 9 wherein said external data source comprises at least one database.

11. The method of claim 9 wherein said reference identifies a position in said external data source.

12. The method of claim 1 wherein said processing criteria comprises a set of rules defining a type of said processing to be applied to said data.

13. The method of claim 12 wherein said processing comprises searching for a set of bits in said data from a plurality of stored sets of bits.

14. The method of claim 13 wherein said searching comprises determining if a computer virus is present in said data.

15. The method of claim 1 wherein said data is encrypted with at least one method of cryptography.

16. The method of claim 15 wherein said processing criteria comprises at least one method of cryptography.

17. The method of claim 15 wherein said indicator comprises a reference to at least one cryptographic key.

18. The method of claim 1 wherein said data comprises an electronic mail message.

19. The method of claim 1 wherein said data comprises packet data.

20. The method of claim 1 wherein said transferring further comprises reading information associated with said indicator to determine how to resume processing.

21. The method of claim 1 further comprising:
resuming processing by at least one of said plurality of processing nodes.

22. The method of claim 1 further comprising:
transferring said processing from said second processing node to a third processing node based on said processing criteria.

23. The method of claim 1 wherein said executing processing further comprises updating said indicator to store progress information.

24. A method for progressively processing data comprising:
receiving data at a first node associated with a plurality of processing nodes;
associating an indicator comprising a state of progress with said data, wherein said associating depends on processing criteria comprising a type of said processing to be applied to said data;
executing processing of said data wherein an amount of said processing depends upon said state of progress;
modifying said indicator to identify a point to resume processing;
transferring said processing to a second processing node based on said processing criteria;
executing processing of said data at said second processing node wherein said processing performed by said second processing node begins at said point.

25. The method of claim 24 wherein at least one of said plurality of processing nodes performs said associating.

26. The method of claim 24 wherein said state of progress indicates said amount of processing already performed.

27. The method of claim 24 wherein said indicator further comprises a result of said processing.

28. The method of claim 24 wherein said indicator comprises a reference to an amount of data processed.

29. The method of claim 28 wherein said reference comprises a pointer.

30. The method of claim 28 wherein said reference comprises a value.

31. The method of claim 24 wherein said indicator further comprises a pointer to a size of said data.

32. The method of claim 24 wherein said indicator comprises a reference to an external data source.

33. The method of claim 32 wherein said external data source comprises at least one database.

34. The method of claim 33 wherein said reference identifies a position in said external data source.

35. The method of claim 24 wherein said processing criteria comprises a set of rules defining a type of said processing to be applied to said data.

36. The method of claim 24 wherein said processing comprises searching for a set of bits in said data from a plurality of stored sets of bits.

37. The method of claim 36 wherein said searching comprises determining if a computer virus is present in said data.

38. The method of claim 24 wherein said data is encrypted with at least one method of cryptography.

39. The method of claim 24 wherein said processing criteria comprises at least one method of cryptography.

40. The method of claim 24 wherein said indicator comprises a reference to at least one cryptographic key.

41. The method of claim 24 wherein said data comprises an electronic mail message.

42. The method of claim 24 wherein said data comprises packet data.

43. The method of claim 24 wherein said transferring further comprises reading information associated with said indicator to determine how to resume processing.

44. The method of claim 24 further comprising:
resuming processing by at least one of said plurality of processing nodes.

45. The method of claim 24 further comprising:
transferring said processing from said second processing node to a third processing node based on said processing criteria.

46. A method for progressively processing data comprising:
receiving data at a first node of a plurality of processing nodes;
associating an indicator with said data depending on processing criteria, said indicator comprising a state of progress;
executing processing of said data wherein amount of said processing depends upon said state of progress, said processing comprising searching for sets of bits in said data from a plurality of stored bits;
modifying said indicator to identify a point to resume said processing;
transferring said processing to a second processing node based on said processing criteria;
executing processing of said data at said second processing node wherein said processing performed by said second processing node begins at said point.

47. The method of claim 46 wherein said searching comprises determining if a computer virus is present in said data.

48. The method of claim 46 wherein said indicator comprises a reference to an external data source comprising computer virus data.

49. The method of claim 49 wherein said reference identifies a position in said external data source.

50. A computer program product comprising:
a computer usable medium having computer readable program code for progressively processing data embodied therein, said computer readable program code configured to:
receive data at a first node of a plurality of processing nodes;
associate an indicator comprising a state of progress with said data;
execute processing of said data wherein amount of said processing depends upon said state of progress;
transfer said processing to a second processing node based on processing criteria.

51. An apparatus for progressively processing data comprising:
a processor;
memory coupled to said processor;
a mechanism for receive data at a first node of a plurality of processing nodes executing in said memory;
said mechanism configured to associate an indicator comprising a state of progress with said data;
said mechanism configured to execute processing of said data wherein amount of said processing depends upon said state of progress;
said mechanism configured to transfer said processing to a second processing node based on processing criteria.

52. A computer program product comprising:
a computer usable medium having computer readable program code for progressively processing data embodied therein, said computer readable program code configured to:
receive data at a first node associated with a plurality of processing nodes;
associate an indicator comprising a state of progress with said data, wherein said associating depends on processing criteria comprising a type of said processing to be applied to said data;
execute processing of said data wherein an amount of said processing depends upon said state of progress;
modify said indicator to identify a point to resume processing;
transfer said processing to a second processing node based on said processing criteria;
execute processing of said data at said second processing node wherein said processing performed by said second processing node begins at said point.

53. An apparatus for progressively processing data comprising:
a processor;
memory coupled to said processor;
a mechanism utilizing said memory, said mechanism configured to receive data at a first node of a plurality of processing nodes executing in said memory;
said mechanism configured to receive data at a first node associated with a plurality of processing nodes;
said mechanism configured to associate an indicator comprising a state of progress with said data, wherein said associating depends on processing criteria comprising a type of said processing to be applied to said data;
said mechanism configured to execute processing of said data wherein an amount of said processing depends upon said state of progress;
said mechanism configured to modify said indicator to identify a point to resume processing;
said mechanism configured to transfer said processing to a second processing node based on said processing criteria;
said mechanism configured to execute processing of said data at said second processing node wherein said processing performed by said second processing node begins at said point.

54. A computer program product comprising:
a computer usable medium having computer readable program code for progressively processing data embodied therein, said computer readable program code configured to:
receive data at a first node of a plurality of processing nodes;
associate an indicator with said data depending on processing criteria, said indicator comprising a state of progress;
execute processing of said data wherein amount of said processing depends upon said state of progress, said processing comprising searching for sets of bits in said data from a plurality of stored bits;
modify said indicator to identify a point to resume said processing;
transfer said processing to a second processing node based on said processing criteria;
execute processing of said data at said second processing node wherein said processing performed by said second processing node begins at said point.

55. The computer program product of claim 54 wherein said searching comprises determining if a computer virus is present in said data.

56. The computer program product of claim 55 wherein said indicator comprises a reference to an external data source comprising computer virus data.

57. An apparatus for progressively processing data comprising:
a processor;
memory coupled to said processor;
a mechanism utilizing said memory, said mechanism configured to receive data at a first node of a plurality of processing nodes executing in said memory;
said mechanism configured to associate an indicator with said data depending on processing criteria, said indicator comprising a state of progress;
said mechanism configured to execute processing of said data wherein amount of said processing depends upon said state of progress,
said processing comprising searching for sets of bits in said data from a plurality of stored bits;
said mechanism configured to modify said indicator to identify a point to resume said processing;
said mechanism configured to transfer said processing to a second processing node based on said processing criteria;
said mechanism configured to execute processing of said data at said second processing node wherein said processing performed by said second processing node begins at said point.

58. A method for progressively processing data comprising:
a means for receiving data at a first node of a plurality of processing nodes;
a means for associating an indicator comprising a state of progress with data;
a means for executing processing of said data wherein an amount of said processing depends upon said state of progress;
a means for transferring said processing to a second processing node based on processing criteria.
